(19) United States
(12) Patent Application Publication
(10) Pub. No.: US 2021/0378481 A1
(43) Pub. Date: Dec. 9, 2021

(54) SCRUBBING MECHANISM AND SCRUBBING PAD

(71) Applicant: Dishcraft Robotics, Inc., San Carlos, CA (US)

(72) Inventors: Kevin Yuan Ma, Milpitas, CA (US); Scott Bahl, San Francisco, CA (US)

(21) Appl. No.: 17/343,689

(22) Filed: Jun. 9, 2021

Related U.S. Application Data
(60) Provisional application No. 63/036,709, filed on Jun. 9, 2020.

(51) Int. Cl. A47L 15/37

(52) U.S. Cl. CPC A47L 15/37

(57) ABSTRACT

Embodiments of a scrubbing mechanism and scrubbing pad are disclosed. An embodiment of a scrubbing pad includes a structure of molded non-absorbent elastomeric material having, a scrubbing portion, a first attachment portion configured to enable attachment to a first wing of a scrubbing mechanism, first leaf springs connected between the scrubbing portion and the first attachment portion, a second attachment portion configured to enable attachment to a second wing of the scrubbing mechanism, and second leaf springs connected between the scrubbing portion and the second attachment portion.

### CROSS-REFERENCE TO RELATED APPLICATION

This application is entitled to the benefit of provisional U.S. Patent Application Ser. No. 63/036,709, filed Jun. 9, 2020, which is incorporated by reference herein.

### BACKGROUND

In order to clean dishware such as plates and bowls effectively, with minimal energy, water, and/or chemicals, applying direct mechanical forces to the food soil at the surface of the ware produces a desirable result. In some cases, applying direct mechanical shear forces to the food soil at the surface and along the surface of a ware effectively cleans the ware with very low total energy consumption, water usage, and/or chemicals. An abrasive sponge with physical force is one technique that is commonly used today in practice in residential ware washing to quickly and effectively remove hard-to-remove food soil from wares. In this residential context, however, humans are not under the same time, resource, and regulatory constraints that one finds in a commercial kitchen. There is a need to effectively clean dishware with minimal energy, water, and/or chemicals, in a resource efficient manner.

### SUMMARY

Embodiments of a scrubbing mechanism and scrubbing pad are disclosed. An embodiment of a scrubbing pad includes a structure of molded non-absorbent elastomeric material having, a scrubbing portion, a first attachment portion configured to enable attachment to a first wing of a scrubbing mechanism, first leaf springs connected between the scrubbing portion and the first attachment portion, a second attachment portion configured to enable attachment to a second wing of the scrubbing mechanism, and second leaf springs connected between the scrubbing portion and the second attachment portion.

In an embodiment, the scrubbing portion includes a spine element, and wherein the first leaf springs and the second leaf springs are connected to the spine element.

In an embodiment, the first attachment portion is connected to the spine element by a first loop and the second attachment portion is connected to the spine element by a second loop.

In an embodiment, the first leaf springs and the second leaf springs are connected to the spine element by living hinges.

In an embodiment, wherein the first attachment portion is connected to the spine element by a first loop and the second attachment portion is connected to the spine element by a second loop, and wherein the first leaf springs and the second leaf springs are connected to the spine element by living hinges.

In an embodiment, the scrubbing pad further includes flaps connected to the spine element.

In an embodiment, the scrubbing pad further includes flaps connected to the spine element opposite the leaf springs.

In an embodiment, the scrubbing pad further includes flaps/fins connected to the spine element and angled to be non-perpendicular relative to a width dimension of the spine element.

In an embodiment, the first attachment portion and the second attachment portion are radially symmetric.

In an embodiment, the first attachment portion includes a first attachment feature configured to attach to an attachment feature of the scrubbing mechanism, and the second attachment portion includes a second attachment feature configured to attach to an attachment feature of the scrubbing mechanism.

In an embodiment, the first and second attachment features are raised attachment features.

In an embodiment, the first and second attachment features are T-shaped attachment rails.

In an embodiment, the first and second attachment features include flaps that include a connection element.

Another embodiment of a scrubbing pad includes a structure of molded non-absorbent elastomeric material having, a horizontal scrubbing portion having a horizontal scrubbing surface, a first angled attachment and scrubbing portion having a first angled scrubbing surface, wherein the first angled attachment and scrubbing portion includes first leaf springs, a second angled attachment and scrubbing portion having a second angled scrubbing surface, wherein the second angled attachment and scrubbing portion includes second leaf springs, wherein the first angled scrubbing surface is angled relative to the horizontal scrubbing surface, and wherein the second angled scrubbing surface is angled relative to the horizontal scrubbing surface.

In an embodiment, the horizontal portion, the first angled attachment and scrubbing portion, and the second angled attachment and scrubbing portion are formed in part by a spine element.

In an embodiment, the first leaf springs are connected to the spine element and wherein the second leaf springs are connected to the spine.

In an embodiment, the first set of leaf springs are connected to the spine element by living hinges and wherein the second set of leaf springs are connected to the spine by living hinges.

Another embodiment of a scrubbing pad includes a structure of molded non-absorbent elastomeric material having, a spine element, leaf springs connected to the spine element, and flaps connected to the spine element opposite the leaf springs.

In an embodiment, the leaf springs are connected to the spine element by living hinges.

In an embodiment, the structure of molded non-absorbent elastomeric material includes a first attachment portion configured to enable attachment to a first wing of a scrubbing mechanism, and a second attachment portion configured to enable attachment to a second wing of the scrubbing mechanism.

In an embodiment, the scrubbing pad further includes first leaf springs connected to the first attachment portion and second leaf springs connected to the second attachment portion.

Another embodiment of a scrubbing pad a monolithic structure of molded non-absorbent elastomeric material having, a spine element having a first major surface and a second major surface, leaf springs connected to the spine element at the first major surface, and flaps connected to the spine element at the second major surface.

An embodiment of a scrubbing mechanism includes a linkage base, a retractable pressure plate, a first wing rotatably connected to the retractable pressure plate and to the linkage base, the first wing including a scrubbing pad attachment feature, and a second wing rotatably connected to the retractable pressure plate and to the linkage base, the second wing including a scrubbing pad attachment feature, wherein the first and second wings are connected to the retractable pressure plate and to the linkage base such that linear motion of the retractable pressure plate relative to the linkage base translates to rotational motion of the first and second wings.

In an embodiment, the retractable pressure plate has a range of motion relative to the linkage base that can linearly translate from an extended position to a retracted position.

In an embodiment, the rotational motion of the first and second wings is rotational motion about pivots at the retractable pressure plate.

In an embodiment, the linkage base includes a spring mechanism configured to maintain the retractable pressure plate in the extended position.

In an embodiment, the scrubbing mechanism further includes a scrubbing pad having a structure of molded non-absorbent elastomeric material having, a spine element, leaf springs connected to the spine element, and flaps connected to the spine element opposite the leaf springs.

In an embodiment, the scrubbing mechanism further includes a scrubbing pad having a structure of molded non-absorbent elastomeric material having, a spine element, a first attachment portion attached to the first wing of the scrubbing mechanism, first leaf springs connected between the spine element and the first attachment portion, a second attachment portion attached to the second wing of the scrubbing mechanism, and second leaf springs connected between the spine element and the second attachment portion.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIGS. 1A and 1B are front and side views, respectively, of an embodiment of a scrubbing assembly that can be used to clean a variety of differently shaped articles of dishware.

FIG. 2 is a perspective view of the scrubbing assembly of FIGS. 1A and 1B.

FIG. 3 is a perspective view of the scrubbing assembly of FIGS. 1A and 1B.

FIG. 4 is another perspective view of the scrubbing assembly of FIGS. 1A and 1B.

FIGS. 5A and 5B are front and side views, respectively, of the scrubbing pad alone and not attached to the scrubbing mechanism.

FIG. 5C is a cross-sectional view of the attachment feature of the scrubbing pad at section C-C of FIG. 5A.

FIG. 6 is a perspective view of the scrubbing pad shown in FIGS. 5A-5C.

FIG. 7 illustrates overlapping regions of contact between the flaps and a dish to be cleaned as the scrubbing pad is rotated about its center axis.

FIGS. 8A-8C illustrate movement of the scrubbing mechanism is three different positions.

FIG. 9 is a perspective view of the scrubbing mechanism.

FIG. 10 is an end perspective view of the scrubbing assembly.

FIG. 11 is another end perspective view of the scrubbing assembly.

FIG. 12 shows an example of the scrubbing pad of the scrubbing assembly pressed against a plate that is sitting on a work surface.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

The systems and methods described herein include a scrubbing assembly that is a component of a cleaning device that can effectively clean multiple ware geometries/types, uses little water and energy, does not require chemicals, and is able to pass stringent regulatory bodies such as NSF International (formally known as the National Sanitation Foundation) that enforce cleanliness and sanitization. As used herein, a scrubber assembly refers to a mechanism that directly applies a mechanical scrubbing force, e.g., via a scrubbing pad, to a surface, such as the surface of a ware. In an embodiment, the wares are known a-priori or designed simultaneously with the cleaning systems and methods in order to guarantee that the scrubbing mechanism can effectively clean all of the wares. Uniform pressure across a range of different shaped wares may be tested through simulation as well as through physical prototypes. The terms dishware, ware, and dish may be used interchangeably herein to refer to articles of dishware such as plates, bowls, cups, pots, pans, and other articles that are used to prepare, serve, hold, carry, and/or transport food or beverages for human consumption.

The described systems and methods achieve rapid, effective cleaning across multiple ware types in, for example, a commercial setting with the same cleaning element by succeeding in a few important functional metrics including, for example: having designed compliance and deformations under load that can allow the scrubbing assembly to effectively conform to all the surface geometries of the ware; the scrubbing assembly includes a structure (possibly monolithic) of molded, non-absorbent elastomeric material with a smooth, continuous surface quality for easy cleaning; when under load, the scrubbing assembly creates approximately uniform pressure on all surface areas in contact with the ware; the scrubbing assembly is stiff when under shear load, allowing for effective transfer of shear forces to the ware and food soils on the dish; the design of the scrubbing assembly enables cleaning of the scrubbing assembly itself by being easily disassembled and/or manually cleaned; and the scrubbing assembly is able to withstand high-cycle counts without wearing to the point of degraded performance or failure.

In some embodiments, a cleaning process involves bringing a surface of the ware and a scrubbing pad of a spinning scrubbing assembly into contact with each other, pressing with a force that is sufficient to clean the ware in the time allocated but without requiring excessive rotational torque or wear on the scrubbing assembly. The scrubbing assembly is rotated relative to the ware with one or more rotations to ensure sufficient application of force and repetition to adequately remove food soils. The scrubbing assembly and ware can then be separated and the cleaned ware removed.

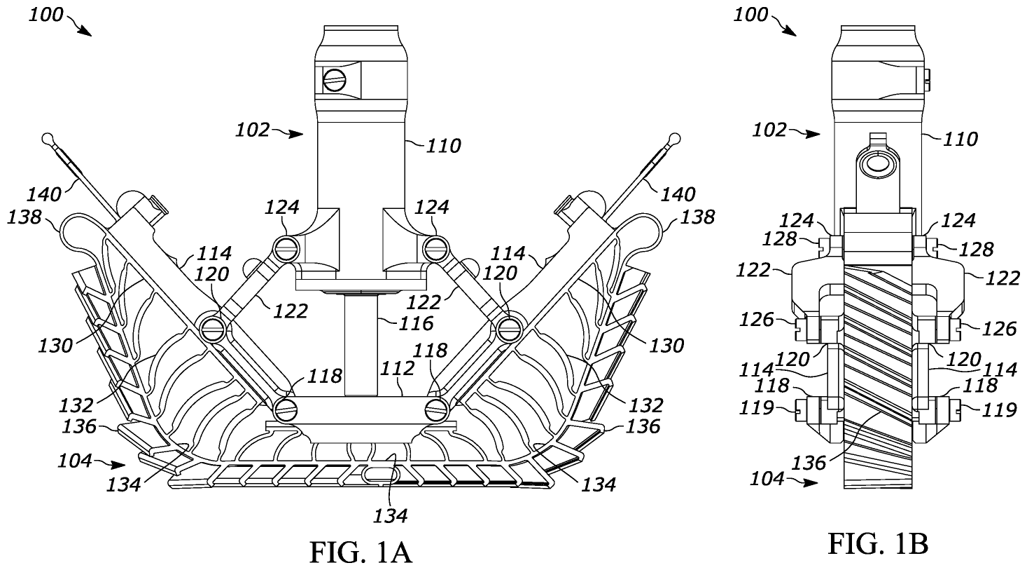

FIGS. 1A and 1B are front and side views, respectively, of an embodiment of a scrubbing assembly 100 that can be used to clean a variety of differently shaped articles of dishware. The scrubbing assembly includes a scrubbing mechanism 102 and a scrubbing pad 104 that is attached to the scrubbing mechanism. The scrubbing assembly is able to adapt as necessary to the various different geometries of differently shaped articles of dishware, including for example, plates and bowls. Both the scrubbing mechanism and the scrubbing pad are described in detail herein.

The scrubbing mechanism 102 includes a linkage base 110, a retractable pressure plate 112, and first and second wings 114 that are connected to both the retractable pressure plate and to the linkage base. Although not shown, in an embodiment, the linkage base is connected to an end effector of a robotic arm and the end effector of the robotic arm is able to rotate to clean dishware. In an embodiment, the linkage base is a cylindrical metallic element that receives a spring loaded shaft 116 that is connected to the retractable pressure plate.

The retractable pressure plate 112 is a plate-like rigid element (e.g., metallic) that enables pressure to be applied to a surface of a dish, for example, to the top surface of a plate or to the inner surface of a bowl. In an embodiment, the retractable pressure plate is a rectangle of approximately 1×2 inches although other shapes and dimensions are possible. For example, the retractable pressure plate has rectangular dimensions in the range of 0.5×6 inches per side although other ranges may apply for larger dishware like mixing bowls, pots, and pans. The retractable pressure plate also includes pivot elements 118 (such as through holes) that enable the wings 114 to be rotatably connected to the retractable pressure plate to form rotational joints. The retractable pressure plate includes a retracting mechanism that enables the retractable pressure plate to move between an extended position and a retracted position. In the embodiment of FIG. 1A, the retracting mechanism includes the spring loaded shaft 116, although other retracting mechanisms could be implemented.

The wings 114 are rigid (e.g., metallic) structures that are rotatably connected to the retractable pressure plate 112 at the pivot elements 118. In an embodiment, the wings include pivot channels that guide a pivot pin 119 that is inserted through the pivot elements of the retractable pressure plate and the pivot channel of the respective wings to create rotatable linkages between the retractable pressure plate and the wings. The wings also include mid-span pivot elements 120 that enable connection of the wings to the linkage base 110 via linkage arms 122. As shown in FIG. 1A, each linkage arm is rotatably connected between the mid-span pivot element of the respective wing and a pivot element 124 of the linkage base by connection pins 126 and 128. As is described herein, the scrubbing mechanism 102 enables the scrubbing pad 104 to be form fitted to dishware having various different shapes, sizes, and/or geometries. Additionally, each wing of the scrubbing mechanism includes at least one scrubbing pad attachment feature that enables the scrubbing pad to be securely attached to the scrubbing mechanism. Scrubbing pad attachment features may include features that run along the length of the wings and end attachment features that are near the tips of the wings.

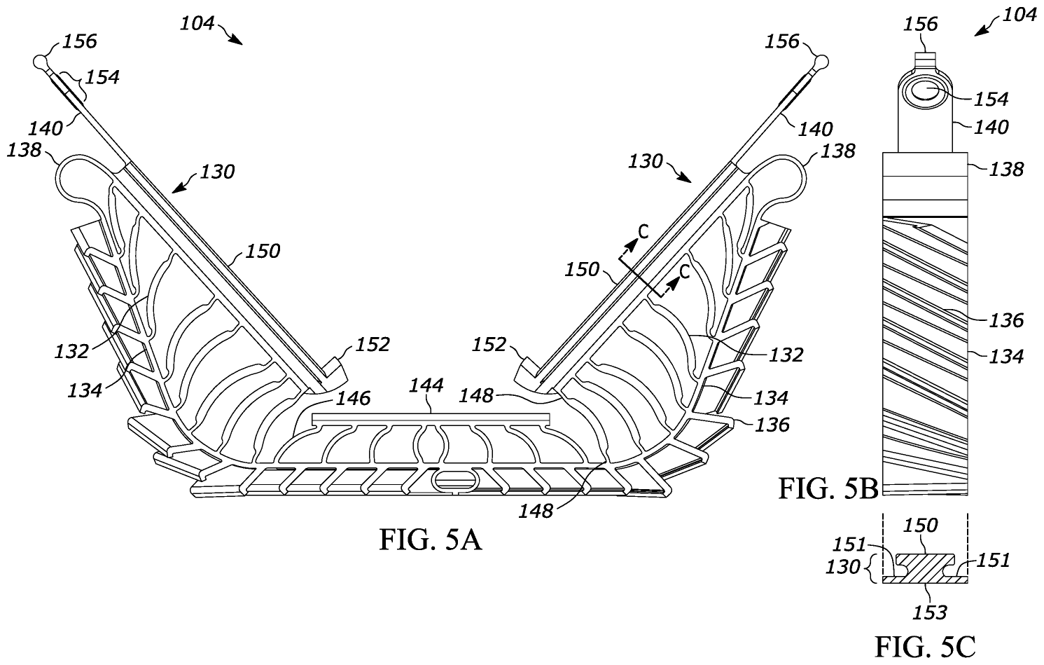

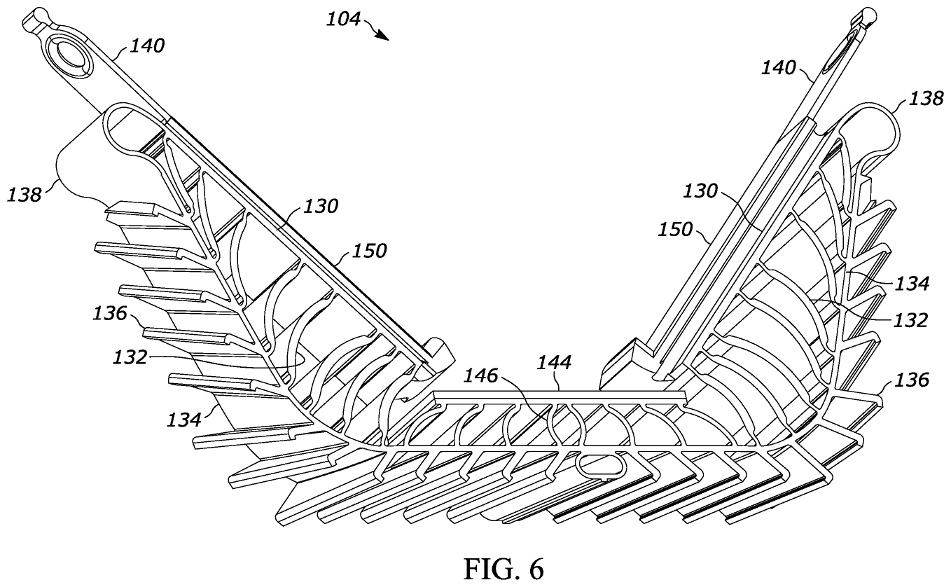

In an embodiment, the scrubbing pad 104 is a structure of molded non-absorbent elastomeric material that includes a scrubbing portion, first and second attachment portions 130, and first and second leaf springs 132, e.g., a first set of leaf springs and a second set of leaf springs that are symmetrical to each other, e.g., radially symmetric about a central axis of the scrubbing pad. The scrubbing pad includes a spine element 134 and flaps 136, or fins, that connect to the spine element. The leaf springs are connected between the attachment portions and the scrubbing portion, e.g., between the attachment portions and the spine element. The first and second attachment elements of the scrubbing pad are connected to the spine element by loops 138. The scrubbing pad also includes end attachment flaps 140 that are connectable to corresponding end attachment features of the wings 114. In an embodiment, the scrubbing pad is a monolithic structure of molded non-absorbent elastomeric material although in other embodiments, the scrubbing pad may be a heterogeneous structure, which may include, for example, a different material (e.g., a stiffer material) integrated into the molded elastomeric material. The scrubbing pad is described in more detail below with reference to FIG. 5A-5C and 6.

FIG. 1B is a side view of the scrubbing assembly of FIG. 1A. The side view shows the linkage base 110, a portion of one linkage arm 122, a portion of one wing 114, the wing/pressure plate pivot pins 119, 126, 128, and a portion of the scrubbing pad 104. FIG. 1B also shows how the flaps 136 of the scrubbing pad are at non-perpendicular angles relative to the length dimension of the scrubbing pad. This design feature of the scrubbing pad is described in more detail below.

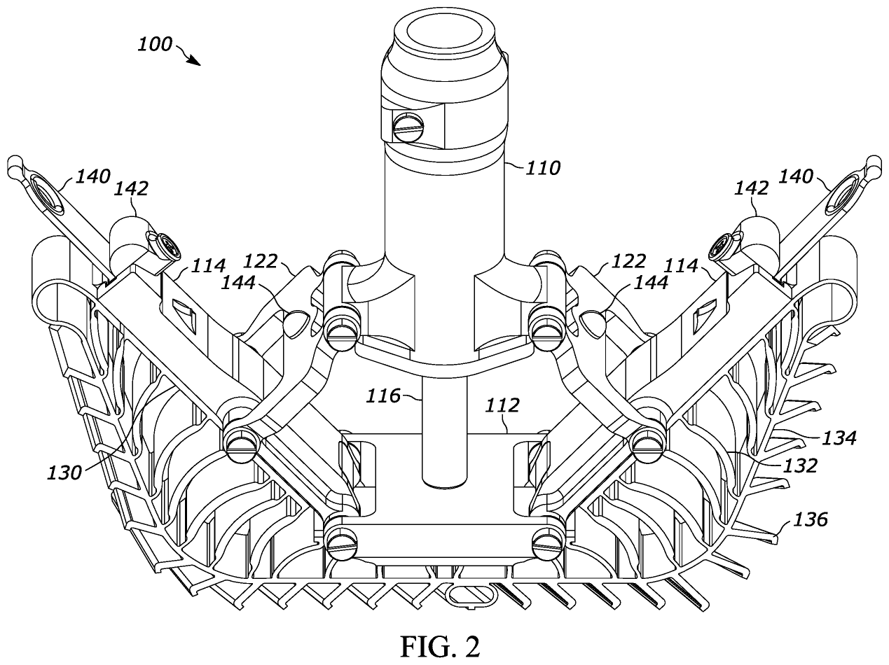

FIG. 2 is a perspective view (e.g., from above) of the scrubbing assembly 100 of FIGS. 1A and 1B. With respect to the scrubbing mechanism 102, FIG. 2 shows the linkage base 110, the retractable pressure plate 112, the wings 114, and the linkage arms 122. With reference to the wings, FIG. 2 also shows end attachment features 142 and with reference to the linkage arms, FIG. 2 also shows bumper elements 144 (e.g., rubber bumper elements), which provide padding to prevent a linkage arm from directly contacting the respective wing, e.g., to avoid metal-on-metal contact between a linkage arm and a wing. With respect to the scrubbing pad 104, FIG. 2 shows the scrubbing portion, at least parts of the first and second attachment portions 130, the leaf springs 132, the spine element 134, and the flaps 136. The perspective view of FIG. 2 provides a view of the end attachment features 140 (in an “unattached” state).

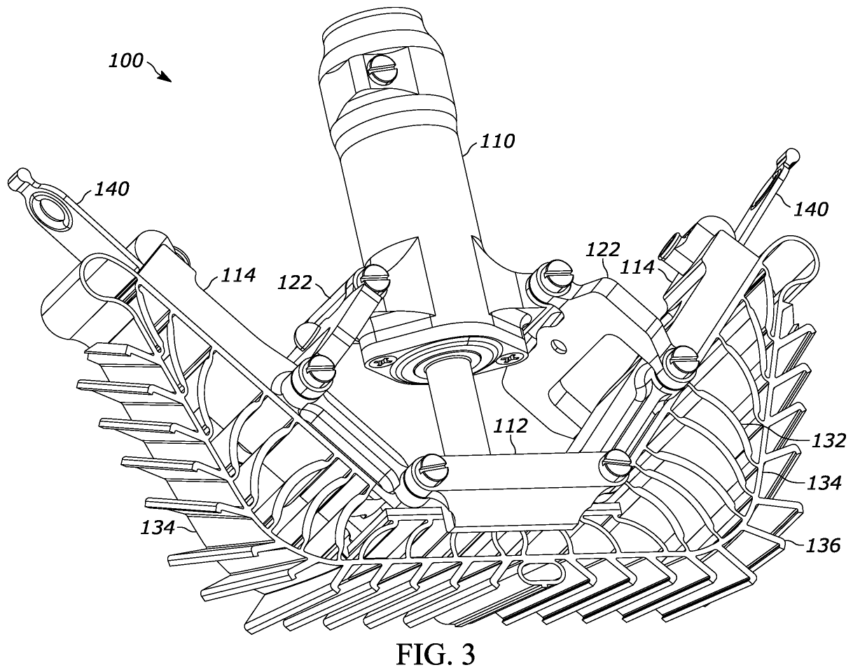

FIG. 3 is a perspective view (e.g., from below) of the scrubbing assembly 100 of FIGS. 1A and 1B. With respect to the scrubbing mechanism 102, FIG. 3 shows the linkage base 110, the retractable pressure plate 112, the wings 114, and the linkage arms 122. With respect to the scrubbing pad 104, FIG. 3 shows the scrubbing portion, at least parts of the first and second attachment portions 140, the leaf springs 132, the spine element 134, and the flaps 136. The perspective view of FIG. 3 provides a view of the angles of the flaps that are associated with the left-side wing and a view of the end attachment features 140 of the scrubber pad (in an “unattached” state).

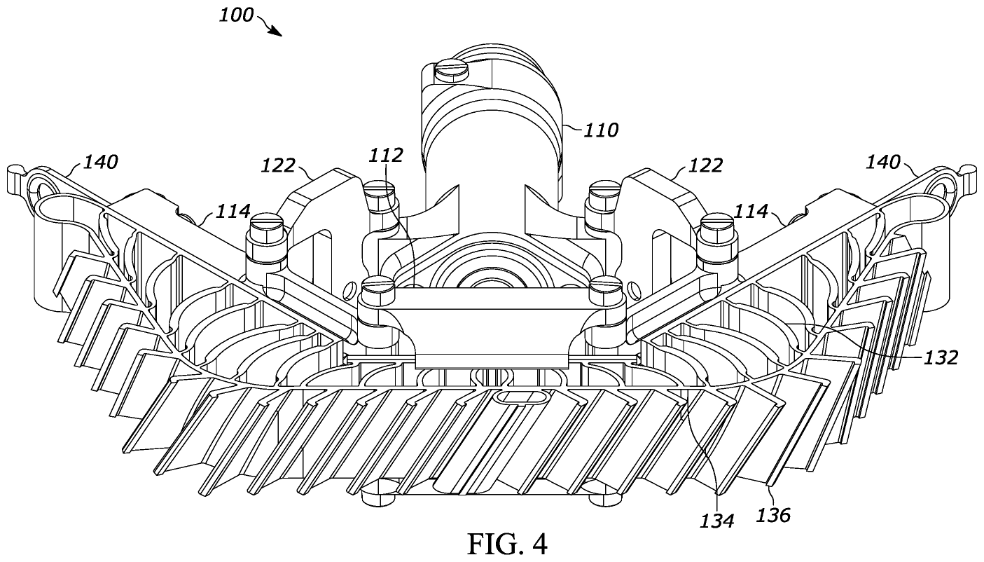

FIG. 4 is another perspective view (e.g., from below) of the scrubbing assembly 100 of FIGS. 1A and 1B. With respect to the scrubbing mechanism 102, FIG. 4 shows the linkage base 110, the retractable pressure plate 112, the wings 114, and the linkage arms 122. With respect to the scrubbing pad 104, FIG. 4 shows the flaps 136, the spine 134, the leaf springs 132, and at least parts of the first and second end attachment portions 140. The perspective view of FIG. 4 provides a view of the angles of the flaps that are at or near the center of the scrubbing pad. FIG. 4 also shows portions of the end attachment features 140 of the scrubber pad (in an “unattached/unconnected” state).

FIGS. 5A and 5B are front and side views, respectively, of the scrubbing pad 104 alone and not attached to the scrubbing mechanism. In an embodiment, the scrubbing pad is a monolithic structure of molded non-absorbent elastomeric material that includes a scrubbing portion, first and second attachment portions 130, and first and second sets of leaf springs 132. In an embodiment, the scrubbing portion of the scrubbing pad includes the spine element 134 and the flaps 136, or fins, that connect to the spine element. In an embodiment, the spine element and the first and second attachment elements include rectangular portions of the structure that include opposing major surfaces. That is, the rectangular portions that constitute the spine element and the first and second attachment elements have thickness dimensions that are much smaller than their length and width dimensions. The leaf springs are connected between the attachment portions and the scrubbing portion, e.g., between a major surface of the attachment portions and a major surface of the spine element. Although a particular number and spacing of leaf springs is shown, the number and locations of the leaf springs may be different from that shown in FIG. 5A. Additionally, in the embodiment of FIG. 5A, the first and second sets of leaf springs are symmetric to each other although in other embodiments, the leaf springs may not be symmetric to each other. In an embodiment, the scrubber pad is about 1 inch wide and spans about 12 inches when fully compressed/flattened and rises up 5-6 inches on the sides when in its at rest, or natural, state, although other dimensions/sizes are possible.

The first and second attachment elements 130 are connected to the spine element 134 by loops 138. The loops help to provide structural stability in the shear force direction when the scrubber assembly is rotated to clean a dish. Although in the embodiment of FIG. 5A the attachment elements are connected to the spine element by loops, the attachment elements could be connected to the spine element in other ways that still provide structural stability in the presence of shear forces. For example, extended portions of the attachment elements and the spine element could be connected in a “V” shape instead of a “loop” shape or an extended portion of the attachment elements and the spine element could be bonded together after molding.

As shown in FIG. 5A, the scrubber pad 104 also includes a central pad structure 144 that corresponds in size and location to the retractable pressure plate. The central pad structure is connected to a major surface of the spine element 134 by leaf springs 146, sometimes referred to herein as central leaf springs. As shown in FIG. 5A, the central leaf springs include a symmetrical arrangement of eight leaf springs, with four leaf springs on either side of center. Additionally, although a particular number and spacing/location of leaf springs is shown, the number and spacing/location of the leaf springs may be different from that shown in FIG. 5A. As shown in FIG. 5A, the central pad structure is not directly connected to the attachment portions 130, which enables the attachment portions of the scrubbing pad to be easily attached to the wings of the scrubbing mechanism.

In the embodiment of FIG. 5A, the leaf springs 132 are connected to the attachment portions 130 and to the spine element 134 by living hinges 148. As is known in the field of molded plastics, a living hinge can be formed by a thin portion of plastic that connects two other portions of the same molded piece of plastic, where the thin portion is thin relative to the two other portions of plastic on either side of the thin portion. The thin portion of plastic provides increased flexibility relative to the two other portions of the molded plastic to provide relative movement (or a “hinge”) between the two other portions. With reference to FIG. 5A, the leaf springs are connected to the attachment portions 130 and to the spine element 134 by living hinges 148. In an embodiment, the living hinges provide flexibility to maintain consistent contact between the scrubbing pad and the dish to be cleaned as the scrubbing assembly rotates around the dish. Although in the embodiment of FIG. 5A, the leaf springs 132 are connected by living hinges on both ends of the leaf springs, other configurations and/or locations of the living hinges are possible. For example, the living hinges may be included along the length of the leaf springs. Further, in some embodiments, living hinges may not be used. In some embodiments, the central leaf springs 146 may also utilize living hinges.

FIGS. 5A and 5B also show the attachment features that are configured to enable the scrubbing pad to be attached to the scrubbing mechanism. In an embodiment, the attachment features include raised features that are configured to attach along the length of the wings and the end attachment features 140 that are configured to attach at the distal ends, or tips, of the wings. In an embodiment, the raised features are rails that run the length of the attachment portions 130 and extend above a major surface of the attachment portions to enable attachment to the wings. In the embodiment of FIG. 5A, the rails are “T” shaped rails that are configured to fit snuggly within corresponding “T” shaped slots that are formed below a major surface of the wings. The rails also include end-stop structures 152 that limit how far the rails can move in the corresponding slots of the wings. FIG. 5C is a cross-sectional view of the attachment feature 150 of the scrubbing pad at section C-C of FIG. 5A that shows a top major surface 151 and a bottom major surface 153 of the attachment feature and a cross-section of the T-shaped rail. Because the rails run the length of the attachment portions 130 of the scrubbing pad 104 and correspond to the length of the wings of the scrubbing mechanism, when attached to the wings of the scrubber mechanism, the attachment features provide stability against shear forces that are created as the scrubbing assembly rotates against a dish during the scrubbing process. As shown in the embodiment of FIGS. 5A and 5B, the attachment features of the scrubbing pad also include the end attachment features 140 that are configured to attach to corresponding end attachment features on the wings of the scrubbing mechanism. For example, the end attachment features of the scrubbing pad are flaps that form a hole 154, which can be secured over corresponding posts on the wings. FIG. 5A shows a front view of the flaps and FIG. 5B shows a side view of one of the flaps. As shown in FIGS. 5A and 5B, each flap includes a tab structure 156 that enables the flaps to be manipulated by person to fold the flaps around the tip of the wings and to secure the holes over corresponding posts on the wings. In an embodiment, the flaps are flexible enough to form around the tips of the wings and to secure onto corresponding posts of the wings. Although the end attachment features of the scrubbing pad include holes in the flaps in the embodiment of FIGS. 5A and 5B, other end attachment features are envisioned. For example, the end attachment features may include snaps or clasps that can be easily manipulated by a person to attach to corresponding snaps/clasps on the wings of the scrubbing mechanism.

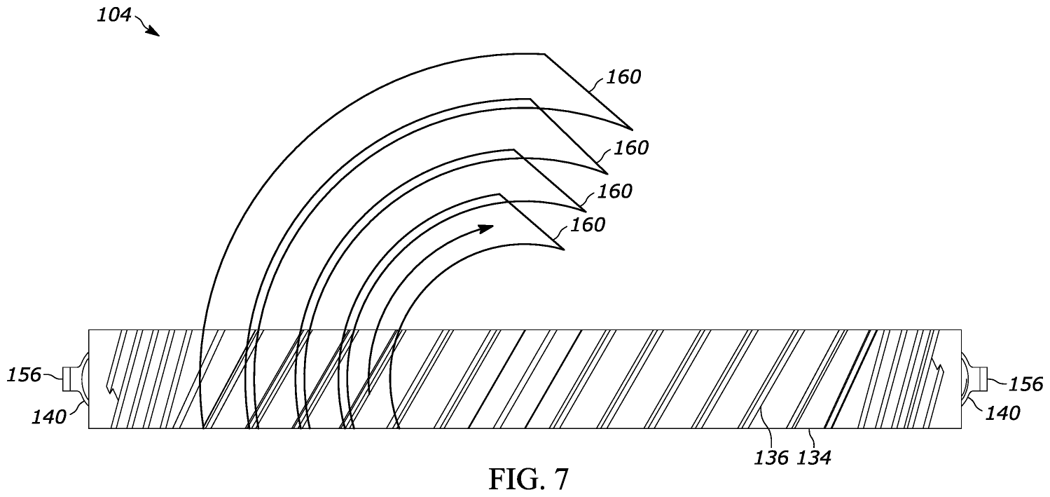

As shown in FIGS. 5A and 5B, the scrubbing pad 104 includes flaps 136 (also referred to as contact flaps or scrubbing flaps) that are connected to the spine element 134. In particular, the flaps are connected to one major surface of the spine element and the leaf springs are connected to another major surface of the spine element, in which the two major surfaces are opposite each other. In the example of FIGS. 5A and 5B, the flaps include ridges or angular portions at the distal ends. It has been found that the ridges provide improved contact with the surface of the dishware (i.e., the surface to be cleaned) as the scrubbing assembly is rotated relative to the dishware. For example, the ridges provide added stiffness to the flaps, which promote more consistent pressure against the dish along the length of the flaps by keeping the flaps from buckling under shear load. Additionally, as shown in FIGS. 5A and 5B, the contact flaps are angled relative to a length dimension of the scrubbing pad. That is, as shown clearly in FIG. 5B, the contact flaps do not run perpendicular to the length dimension of the scrubbing pad (or parallel to the width dimension of the scrubbing pad), but rather are angled relative to the length dimension. For example, the angles of the contact flaps are in the range of 20-60 degrees where zero degrees is a horizontal line straight across the width of the scrubbing pad shown in FIG. 5B and ninety degrees is a vertical line parallel to the outer edges of the pad shown in FIG. 5B. In an embodiment, the angle of the flaps is a function of the width of the scrubbing pad and in one embodiment, the scrubbing pad is 1 inch wide, and the flaps are 2 millimeters thick and are at an angle of 26 degrees. A benefit of angled flaps is described below with reference to FIG. 7. Although an example configuration of a scrubbing pad is described with reference to FIGS. 5A-5C, other configurations of the scrubbing pad are possible. For example, other configurations that still incorporate a molded, non-absorbent elastomeric material with a spine element, leaf springs connected to the spine element, and flaps connected to the spine element opposite the leaf springs are possible.

FIG. 6 is a perspective view (e.g., from below) of the scrubbing pad 104 shown in FIGS. 5A-5C. For example, FIG. 6 shows the attachment portions 130, the T-shaped rails 150, the end attachment features 140, the spine element 134, the leaf springs 132, the loops 138, the central pad structure 144, the central leaf springs 146, and the contact flaps 136.

As shown in FIGS. 5A and 6, the scrubbing pad 104 includes a horizontal scrubbing portion (that includes the central pad structure 144, the central leaf springs 146, and central contact flaps 136) around the center of the scrubbing pad and angled attachment and scrubbing portions at the opposing sides of the scrubbing pad. The angled attachment and scrubbing portions include the attachment portions 130, the angled portions of the spine 134, and the sets of leaf springs 132 that connect between the attachment portions 130 and the spine element 134. It is notable that the angled attachment and scrubbing portions are angled relative to the horizontal scrubbing portion while the scrubbing pad is in an “at rest,” “natural,” or “untensioned” state. That is, the at rest or natural state of the scrubbing pad is intentionally molded with the angular relationship as shown in FIGS. 5A and 6 to provide good contact between the scrubbing pad and a dish to be cleaned regardless of the geometry of the dish to be cleaned, e.g., whether the dish to be cleaned is, for example, a plate or a bowl. In particular, it has been found that a scrubbing pad with an at rest state angled as shown in FIGS. 5A and 6 provides improved contact (and thus better cleaning ability) over a set of dishes that includes both plates and bowls than a scrubbing pad that is entirely flat (e.g., horizontal) in an at rest, natural, or untensioned state.

As mentioned above, the angle of the contact flaps relative to the length dimension of the scrubbing pad can provide certain benefits when cleaning dishes such as plates and bowls. For example, the angle of the flaps can provide overlapping areas of contact between the flaps and the dishware (i.e., coverage of a cleaning area) as the scrubbing assembly is rotated during a cleaning operation. FIG. 7 illustrates overlapping regions 160 of contact between the flaps and a dish to be cleaned as the scrubbing pad is rotated about its center axis while in contact with, which result from angling the contact flaps at a non-perpendicular angle relative to the length dimension of the scrubbing pad. FIG. 7 also illustrates that the contact area between the scrubbing pad and a dish is a function of the spacing between flaps and the angle of each flap relative to the length dimension of the scrubbing pad.

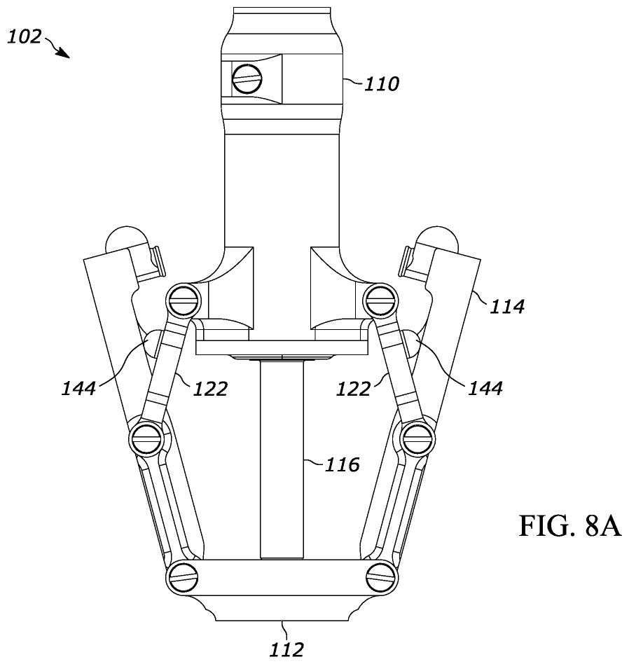

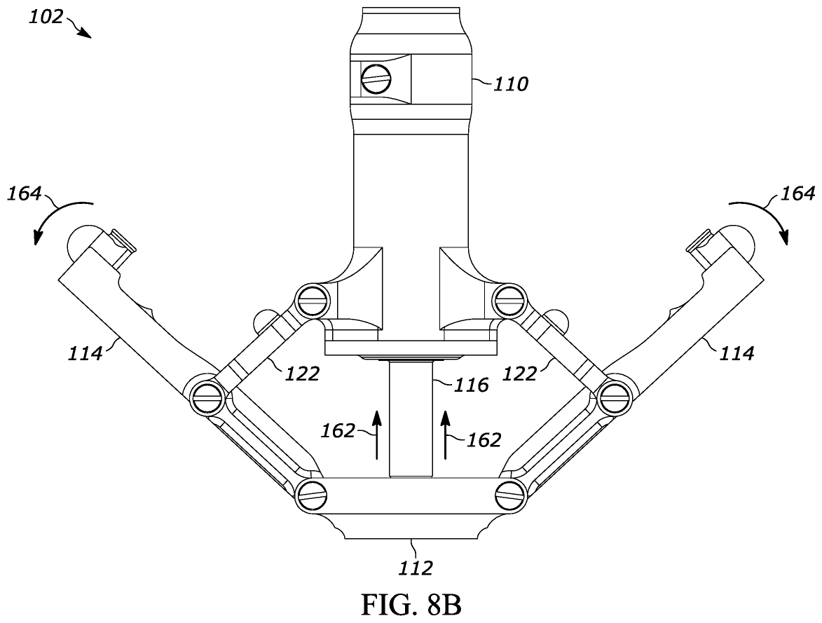

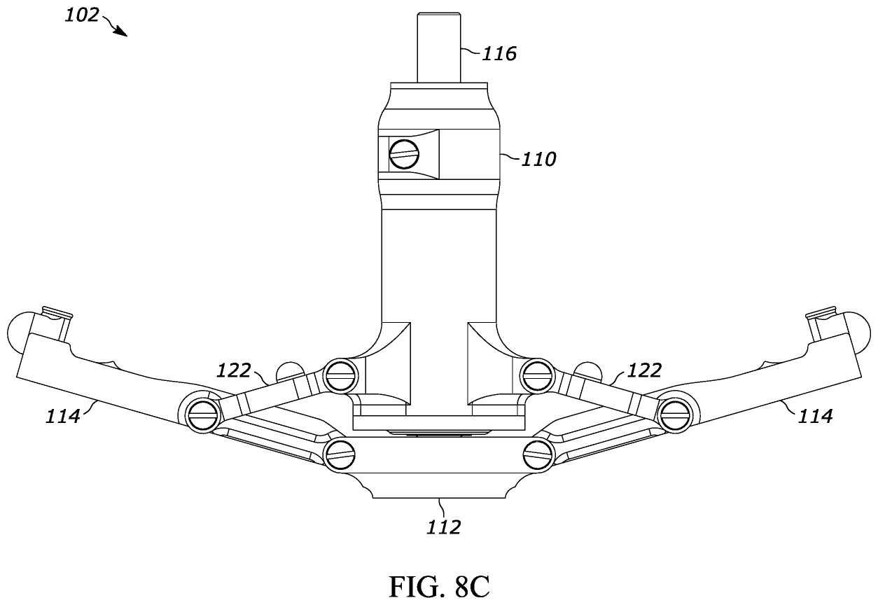

Movement of the scrubbing mechanism 102 is now described with reference to FIGS. 8A-8C. With reference to FIG. 8A, in an embodiment, the retractable pressure plate 112 is spring loaded to maintain the retractable pressure plate in an extended position in the absence of pressure applied at the pressure plate. For example, the linkage base includes a spring mechanism internal to the linkage base that is configured to maintain the retractable pressure plate in the extended position. FIG. 8A also illustrates that the bumper elements 144 of the wings 114 are in contact with the linkage arms 122 when the retractable pressure plate is in the extended position. As mentioned above, the bumper elements prevent metal-on-metal contact between the wings and the corresponding linkage arms. In operation of the scrubber assembly, the scrubber assembly is brought into contact with a dish to be cleaned by, for example, a robotic arm that moves the scrubbing assembly towards the dish such that an upward force is applied to the retractable pressure plate, e.g., in response to contact between the scrubbing pad and a surface of the dish. FIG. 8B illustrates an upward force being applied to the retractable pressure plate. In particular, the straight arrows 162 illustrate the upward force and the corresponding linear motion of the retractable pressure plate. As an upward force is applied to the retractable pressure plate and as the retractable pressure plate linearly moves towards the linkage base (e.g., retracts into the linkage base), the pivots and linkage arms cause the wings to rotate about the pivots at the edges of the retractable pressure plate. Rotation of the wings in response to retraction of the retractable pressure plate is illustrated by the curved arrows 164. Rotation of the wings corresponds directly to the linear motion of the retractable pressure plate and rotation of the wings stops when linear motion of the retractable pressure plate stops. FIG. 8C illustrates the scrubbing mechanism when the retractable pressure plate is in the retracted position. In the retracted position, further movement of the retractable pressure plate is prevented by contact between the pressure plate and the linkage base. As illustrated by FIGS. 8A-8C, the retractable pressure plate has a range of motion that goes from the extended position as shown in FIG. 8A to the retracted position as shown in FIG. 8C. Additionally, in the retracted position, the spring loaded retractable pressure plate is fully sprung. That is, the force applied by a spring element is at its greatest over the range of motion when the retractable pressure plate is fully retracted.

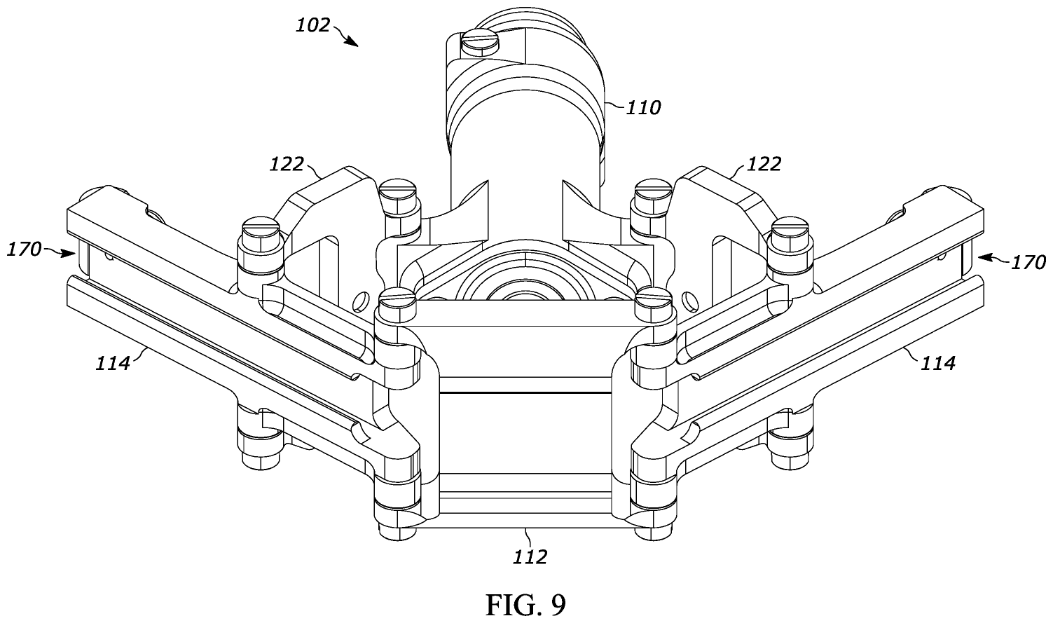

FIG. 9 is a perspective view (e.g., from below) of the scrubbing mechanism 102 described above. FIG. 9 shows the linkage base 110, the retractable pressure plate 112, the wings 114, the linkage arms 122, and the pivots that provide rotatable connections between the linkage base, the retractable pressure plate, the wings, and the linkage arms. FIG. 9 also shows slots 170 in the wings that serve as the attachment features that mate with the attachment features (e.g., the T-shaped rails) of the scrubbing pad 104. As shown in FIG. 9, the wings include T-shaped slots and the T-shaped slots are sized and shaped to snugly receive the T-shaped rails of the scrubbing pad. Although T-shaped slots are described as attachment features, other configurations of attachment features are possible.

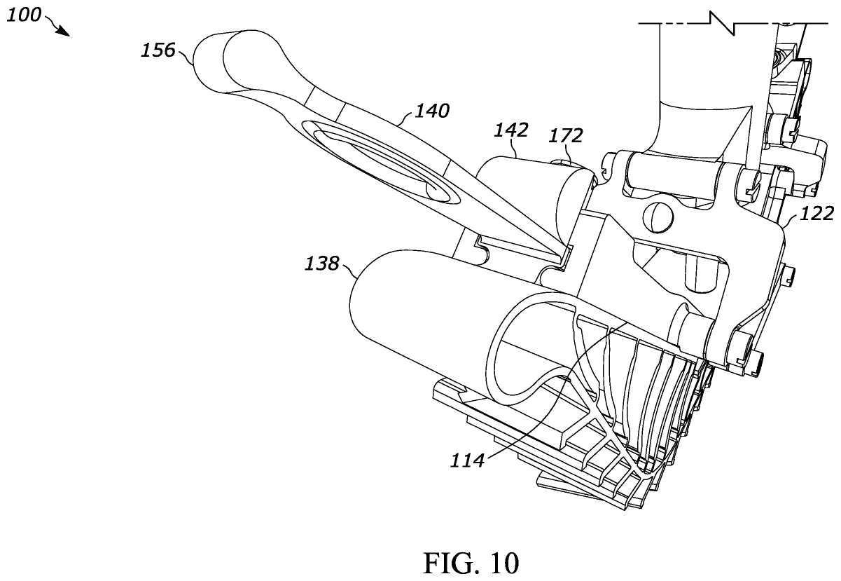

FIG. 10 is an end perspective view of the scrubbing assembly 100 that shows the loop 138 of the scrubbing pad and the flap of the scrubbing pad that serves as the end attachment feature 140. FIG. 10 also shows a portion of a curved end attachment element 142 of the wing 114 around which the end attachment feature of the scrubbing pad is bent during the attachment process. For example, and although not shown in FIG. 10, the tab 156 of an end attachment feature 140 can be manipulated/bent around the curved end attachment element and then secured over a corresponding post 172 on the wing to securely attach the scrubbing pad to the wing of the scrubbing mechanism.

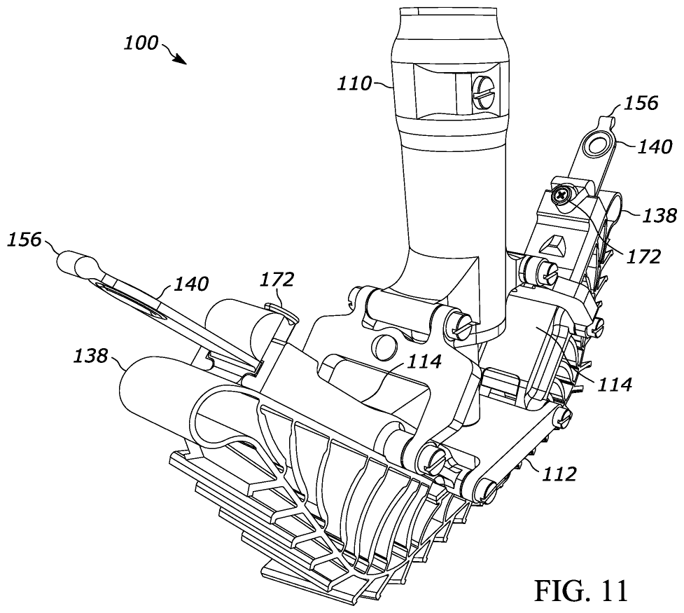

FIG. 11 is another end perspective view of the scrubbing assembly 100 that shows both wings 114 of the scrubbing mechanism as well as portions of the scrubbing pad and the flap of the scrubbing pad that serves as the end attachment feature 140. FIG. 11 also shows that the flaps of the end attachment features of the scrubbing pad are not secured to the posts 172 of the wings, but in operation, the flaps would be wrapped around the ends of the wings and secured, via the holes, to the corresponding posts.

In an embodiment, when the scrubbing pad is a single piece, it is easier to manufacture and easier for a user to replace or remove for cleaning. In an embodiment, the linkage mechanism conforms to large, macro differences in ware geometries when pressed into a ware, for example the differences between a bowl and a plate. For a bowl, the wings do not push down very far before the compliant scrubbing pad compresses against the side walls of the bowl, but for a plate the wings will extend until nearly flat.

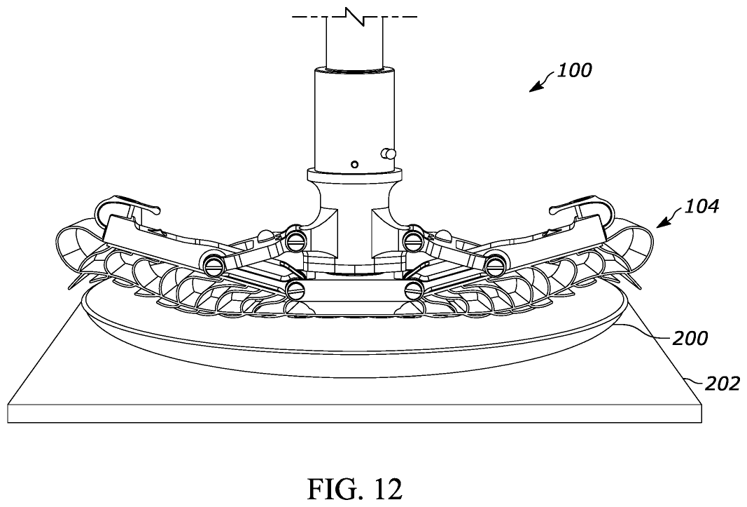

FIG. 12 shows an example of the scrubbing pad 104 of the scrubbing assembly 100 pressed against a plate 200 that is sitting on a work surface 202, with the scrubbing pad significantly compressed. As shown in FIG. 12, the wings are rotated into a nearly horizontal position, similar to the position shown in FIG. 8C. In the case of a bowl, the wings would be in rotated much more “upwards,” similar to the positions shown in FIGS. 8A and 8B. In operation, the scrubbing assembly is rotated relative to the plate to clean the plate. Although FIG. 12 shows a plate, regardless of the exact shape of the dishware, the scrubbing assembly will confirm the position of its wings to apply the scrubbing pad over the entire exposed surface area of the article of dishware.

In some embodiments, the scrubbing mechanism of the scrubber assembly is capable of being easily disassembled to clean the scrubbing assembly with simple screws. The entire scrubbing assembly itself is mounted to a rotary degree of freedom that can reside in any cleaning system; this mount can be permanent or removable to enable service, upgrades, or new linkages to support other wares with the same rotational actuator. The rotation degree of freedom can be fixed and the wares to be cleaned are brought to it, or the linkage itself can be moved to be brought into and out of contact with the ware by being attached to a linear degree of freedom, another linkage mechanism, or even something more complex like a robot arm.

In some embodiments, the compliant scrubbing pad is designed to be made of a rubber-like element that can be easily removed and attached by hand to the scrubbing mechanism. In an embodiment, the scrubbing pad is molded from a single monolithic casting of rubber such as polyurethane, for example, a polyurethane having a hardness/durometer in the range of 50 A-100 A. In an embodiment, the compliant scrubbing pad is rigidly coupled to the linkage mechanism in order to effectively transfer shear forces for removing food soil as well as normal forces for promoting even pressure along the length of the scrubber pad.

In one embodiment, the scrubbing pad may be slid into a channel of the wings of the scrubbing mechanism, sliding down from the tip of one wing down along the length of the wing. In other embodiments, the scrubbing pad may attach with a snapping interlocking feature or similar mechanism. In some implementations, there may need to be additional constraints that are required to keep the scrubbing pad from sliding out from the channels of the wings. In these implementations, features like elements that wrap around the end of the linkages or other clasping mechanisms can be used to prevent undesired sliding of the scrubbing pad relative to the scrubbing mechanism.

The part of the scrubbing pad that contacts the ware surface and performs the work of scrubbing may be referred to as the “wiper.” In some embodiments, the wiper itself is approximating a line contact along the diameter of the ware that is then rotated about the center axis of the ware in order to create shear forces across the entire surface of the ware. There may be competing desires when choosing the thickness of the scrubbing pad. On one hand, having a very wide compliant scrubbing pad allows for transmission of larger shear forces without significant twisting and shear buckling of the compliant scrubbing pad that could degrade cleaning performance and/or uniform pressure along the length of the wiper. However, if the scrubbing pad is too wide on a smaller, round ware, the wiper may only contact at its outer edges, standing above and not make any contact with the ware surface directly under the scrubbing pad, which may cause uneven wear of the pad, buckling of the scrubbing pad, and uneven cleaning performance. A thinner scrubbing pad may achieve a better approximation of the profile of the ware surface at its diameter and may have better pressure distribution resulting in more uniform wear and cleaning.

In some implementations, an array of thin compliant elements support the wiper of the compliant scrubbing pad, offset some distance from the linkage mechanism. The thin elements may be as wide or wider than the nominal width of the scrubbing pad; their width enables the compliant elements to transmit large shear forces between the linkage and the wiper. However, the elements are also long and thin so as to bend and absorb large deflections in the normal direction that occur when pressing into wares of different geometries. The thin compliant elements may be leaf-spring-like that themselves are tuned to ensure they apply roughly uniform pressure across all wares while also being able to accommodate meso-scale surface geometry variations between wares, such as the different inner bend radii in different bowls or plates. Care is taken to design the areas where these leaf springs attach to the bulk material along the linkage as well as along the wiper to reduce bending moments that may peel the wiper away from the ware. Although examples of leaf springs have been described above, other embodiments of leaf springs may be implemented.

In an embodiment, the scrubbing pad includes flaps that project from the scrubbing pad to conform to micro level geometries that vary from dish to dish, even of the same ware type, such as due to manufacturing differences. The wiper contact line is broken up into many smaller contact lines per flap. The flaps may be oriented with a twist, e.g., at a 45 degree angle in the wiper plane, in order to overlap their contact lines all along the wiper's length. This angular orientation can maintain scrubbing contact all along the length of the wiper without contributing additional bending stiffness to the wiper that would compromise its compliance to ware geometries.

Although the scrubbing mechanism has been described above as having only two wings (with corresponding scrubbing pad elements), the scrubbing mechanism (and corresponding scrubbing pad) may include more than two wings. For example, the scrubbing mechanism and scrubbing may have three “wings” evenly distributed around a central axis (e.g., at 120 degree increments) or the scrubbing mechanism and scrubbing may have four “wings” evenly distributed around a central axis, e.g., at 90 degree increments.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A scrubbing pad comprising:
a structure of molded non-absorbent elastomeric material having;
a scrubbing portion;
a first attachment portion configured to enable attachment to a first wing of a scrubbing mechanism;
first leaf springs connected between the scrubbing portion and the first attachment portion;
a second attachment portion configured to enable attachment to a second wing of the scrubbing mechanism; and
second leaf springs connected between the scrubbing portion and the second attachment portion.

2. The scrubbing pad of claim 1, wherein the scrubbing portion includes a spine element, and wherein the first leaf springs and the second leaf springs are connected to the spine element.

3. The scrubbing pad of claim 2, wherein the first attachment portion is connected to the spine element by a first loop and the second attachment portion is connected to the spine element by a second loop.

4. The scrubbing pad of claim 2, wherein the first leaf springs and the second leaf springs are connected to the spine element by living hinges.

5. The scrubbing pad of claim 2, wherein the first attachment portion is connected to the spine element by a first loop and the second attachment portion is connected to the spine element by a second loop, and wherein the first leaf springs and the second leaf springs are connected to the spine element by living hinges.

6. The scrubbing pad of claim 2, further including flaps connected to the spine element.

7. The scrubbing pad of claim 2, further including flaps connected to the spine element opposite the leaf springs.

8. The scrubbing pad of claim 2, further including flaps/fins connected to the spine element and angled to be non-perpendicular relative to a width dimension of the spine element.

9. The scrubbing pad of claim 2, wherein the first attachment portion and the second attachment portion are radially symmetric.

10. The scrubbing pad of claim 1 wherein:
the first attachment portion includes a first attachment feature configured to attach to an attachment feature of the scrubbing mechanism; and
the second attachment portion includes a second attachment feature configured to attach to an attachment feature of the scrubbing mechanism.

11. The scrubbing pad of claim 10, wherein the first and second attachment features are raised attachment features.

12. The scrubbing pad of claim 10, wherein the first and second attachment features are T-shaped attachment rails.

13. The scrubbing pad of claim 10, wherein the first and second attachment features includes flaps that include a connection element.

14. A scrubbing pad comprising:
a structure of molded non-absorbent elastomeric material having;
a horizontal scrubbing portion having a horizontal scrubbing surface;
a first angled attachment and scrubbing portion having a first angled scrubbing surface, wherein the first angled attachment and scrubbing portion includes first leaf springs;
a second angled attachment and scrubbing portion having a second angled scrubbing surface, wherein the second angled attachment and scrubbing portion includes second leaf springs;
wherein the first angled scrubbing surface is angled relative to the horizontal scrubbing surface; and
wherein the second angled scrubbing surface is angled relative to the horizontal scrubbing surface.

15. The scrubbing pad of claim 14, wherein the horizontal portion, the first angled attachment and scrubbing portion, and the second angled attachment and scrubbing portion are formed in part by a spine element.

16. The scrubbing pad of claim 14, wherein the first leaf springs are connected to the spine element and wherein the second leaf springs are connected to the spine.

17. The scrubbing pad of claim 14, wherein the first set of leaf springs are connected to the spine element by living hinges and wherein the second set of leaf springs are connected to the spine by living hinges.

18. A scrubbing pad comprising:
a structure of molded non-absorbent elastomeric material having;
a spine element;
leaf springs connected to the spine element; and
flaps connected to the spine element opposite the leaf springs.

19. The scrubbing pad of claim 18, wherein the leaf springs are connected to the spine element by living hinges.

20. The scrubbing pad of claim 19, wherein the structure of molded non-absorbent elastomeric material includes a first attachment portion configured to enable attachment to a first wing of a scrubbing mechanism, and a second attachment portion configured to enable attachment to a second wing of the scrubbing mechanism.

21. The scrubbing pad of claim 20, further including first leaf springs connected to the first attachment portion and second leaf springs connected to the second attachment portion.

22. A scrubbing pad comprising:
a monolithic structure of molded non-absorbent elastomeric material having;
a spine element having a first major surface and a second major surface;
leaf springs connected to the spine element at the first major surface; and
flaps connected to the spine element at the second major surface.

23. A scrubbing mechanism comprising:
a linkage base;
a retractable pressure plate;
a first wing rotatably connected to the retractable pressure plate and to the linkage base, the first wing including a scrubbing pad attachment feature; and
a second wing rotatably connected to the retractable pressure plate and to the linkage base, the second wing including a scrubbing pad attachment feature;
wherein the first and second wings are connected to the retractable pressure plate and to the linkage base such that linear motion of the retractable pressure plate relative to the linkage base translates to rotational motion of the first and second wings.

24. The scrubbing mechanism of claim 23, wherein the retractable pressure plate has a range of motion relative to the linkage base that can linearly translate from an extended position to a retracted position.

25. The scrubbing mechanism of claim 23, wherein the rotational motion of the first and second wings is rotational motion about pivots at the retractable pressure plate.

26. The scrubbing mechanism of claim 23, wherein the linkage base includes a spring mechanism configured to maintain the retractable pressure plate in the extended position.

27. The scrubbing mechanism of claim 23, further including a scrubbing pad comprising:
a structure of molded non-absorbent elastomeric material having;
a spine element;
leaf springs connected to the spine element; and
flaps connected to the spine element opposite the leaf springs.

28. The scrubbing mechanism of claim 23, further including a scrubbing pad comprising:
a structure of molded non-absorbent elastomeric material having;
a spine element;
a first attachment portion attached to the first wing of the scrubbing mechanism;
first leaf springs connected between the spine element and the first attachment portion;
a second attachment portion attached to the second wing of the scrubbing mechanism; and
second leaf springs connected between the spine element and the second attachment portion.
